(19) United States
(12) Patent Application Publication
(10) Pub. No.: US 2025/0170809 A1
(43) Pub. Date: May 29, 2025

(54) Decorative Anti-Slip Floor Covering Element and Decorative Anti-Slip Floor Covering

(71) Applicant: 14F Licensing NV, Turnhout (BE)

(72) Inventor: Eddy Alberic Boucké, Turnhout (BE)

(21) Appl. No.: 18/724,692

(22) PCT Filed: Dec. 28, 2022
(86) PCT No.: PCT/EP2022/087961

§ 371 Date: Jun. 27, 2024

(30) Foreign Application Priority Data
Dec. 28, 2021 (NL) 2030318

(51) Int. Cl. B32B 27/20; B32B 3/06; B32B 3/30; B32B 27/08; E04F 15/02; E04F 15/10

(52) U.S. Cl. CPC B32B 27/20; B32B 3/06; B32B 3/30; B32B 27/08; E04F 15/02172; E04F 15/105; B32B 2260/02; B32B 2260/04; B32B 2264/303; B32B 2264/403; B32B 2307/554; B32B 2307/744; B32B 2471/00; E04F 15/02038; E04F 15/02188; E04F 2201/0138; E04F 2201/023; E04F 2201/043

(57) ABSTRACT

A decorative anti-slip floor covering element, in particular a floor panel, including a core provided with an upper side and a lower side. A decorative anti-slip floor covering, including a plurality of, preferably interconnected, floor covering elements according to the invention.

### CROSS-REFERENCE TO RELATED APPLICATIONS

This application is the United States national phase of International Patent Application No. PCT/EP2022/087961 filed Dec. 28, 2022, and claims priority to The Netherlands Patent Application No. 2030318 filed Dec. 28, 2021, the disclosures of which are hereby incorporated by reference in their entireties.

### BACKGROUND OF THE INVENTION

### Field of the Invention

The invention relates to a decorative anti-slip floor covering element, in particular a floor panel, comprising a core provided with an upper side and a lower side. The invention also relates to a decorative anti-slip floor covering, comprising a plurality of, preferably interconnected, floor covering elements according to the invention.

### Description of Related Art

During the last decennia, and along with the development of society and the improvement of living standards, requirements in aesthetics and safety of interior decorations are gradually increased. Decorative floor covering elements have been improved significantly the last years, wherein traditional core materials, such as HDF and MDF, have been replaced more and more by thermoplastic materials, in particular PVC due to its waterproof properties and processability. On top of the core, typically a decorative top structure is applied to improve the aesthetical appearance of the floor covering element. However, these polymer based floor covering elements have a poor slip resistance, especially in case the floor covering element is wettened, which causes people to easily slip down, which could lead to injuries. Therefore this polymer based panels are not suitable for use in humid environments, such as bathrooms, swimming pools, or outdoor.

### SUMMARY OF THE INVENTION

It is an object of the present invention to provide a decorative floor covering element, in particular a floor panel, with improved anti-slip properties.

It is a further object of the present invention to provide a polymer, in particular thermoplastic, based decorative floor covering element, in particular a floor panel, with improved anti-slip properties.

It is yet a further object of the present invention to provide an interconnectable polymer, in particular thermoplastic, based decorative floor covering element, in particular a floor panel, with improved anti-slip properties.

At least one of these objects can be achieved by provided a decorative anti-slip floor covering element, in particular a floor panel, comprising:
a core provided with an upper side and a lower side,
a decorative top structure affixed, either directly or indirectly, on said upper side of the core,
   wherein the core comprises at least one base material, in particular a main polymer, preferably a thermoplastic polymer, and a wear-resisting anti-slip substance at least partially embedded in said base material, in particular said main polymer, wherein said anti-slip substance textures the upper side of the core, wherein the textured upper side of the core at least partially defines a textured upper surface of the decorative floor covering element.

The floor covering element according to the invention has several advantages. Firstly, the floor covering element according to the invention has a relatively good anti-slip performance by applying the anti-slip substance, in particular anti-slip particles, in the core which define at least partially the texture of the upper surface of the floor covering element as such. By embedding the anti-slip substance, in particular the anti-slip particles, in at least the core leads to a relatively durable and firm anchoring of the wear-resisting anti-slip substance, in particular anti-slip particles, which secures the desired anti-slip performance throughout the life cycle of the floor covering element with noticeable loss of this anti-slip effect, as the core as such will type not wear during normal use, contrary to the more vulnerable decorative top structure. Typically, the anti-slip substance, in particular the anti-slip particles, as surrounded by material of both the core and the decorative top structure, which will be in favour of realizing a firm anchoring of the anti-slip substance, in particular the anti-slip particles, in or by the panel. Embedding the anti-slip substance by the base material, in particular polymer, (matrix) of the core, will tightly bond this substance, which prevents separation (loosening) of this substance during temperature fluctuations, which also secures a sufficient anti-slip effect at relatively low temperatures. This makes the floor covering elements not only suitable for indoor use, but also for outdoor use. Possible applications are of the anti-slip floor covering element according to the invention are the floor surrounding a sink, a bathroom floor, a kitchen floor, a floor surrounding a swimming pool, and an outdoor floor, such as an outdoor terrace floor, and in other situations where water is easily splashed. An additional advantage of the decorative floor covering element according to the invention is that the core has relatively good sound dampening properties due to the presence of the anti-slip substance, in particular the anti-slip particles. This leads to interfaces between the base material, in particular the main polymer, and the anti-slip substance which hinders the sounds transmission and stimulates the sound absorption, leading to improved acoustic properties of the core, and hence of the decorative floor covering element as such.

In a particular embodiment the decorative top structure comprises at least one decorative layer, for example including a printed décor, preferably covered at least partially be a protective or wear layer. The decorative top structure may fall or ply over the structured upper side of the core, to maintain the anti-slip properties.

Preferably, the base material of the core comprises a (main) polymer, preferably a thermoplastic material, which is more preferably chosen from the group consisting of: PVC, PET, PP, PS, thermoplastic polyurethane (TPU), PE, in particular MDPE and/or HDPE; and combinations thereof. PS may be in the form of expanded PS (EPS) in order to further reduce the density of the floor covering element, which leads to a saving of costs and facilitates handling of the panels. Also in case another thermoplastic material is used, this material may be applied in foamed state in the core to reduce the density and costs. Nevertheless, it is also imaginable that the thermoplastic material used as main polymer is a solid polymer (i.e. an unfoamed polymer). Preferably, at least a fraction of the polymer used may be formed by recycled thermoplastic, such a recycled PVC or recycled PU. It is conceivable that a mix of virgin and recycled thermoplastic material is used to compose at least a part of the core. Instead of the thermoplastic material, also a thermoset polymer may be used, such as thermoset polyurethane.

At least a part of the core may be made of a composite of at least one polymer and at least one non-polymeric material, preferably a non-polymeric material other than the anti-slip substance. The anti-slip substance is preferred embedded in said composite material. The composite of the core layer preferably comprises one or more fillers, wherein at least one filler is preferably selected from the group consisting of: talc, chalk, wood, calcium carbonate, titanium dioxide, calcined clay, porcelain, glass, carbon particles, silicon particular, a (nother) mineral filler, a (nother) natural filler, a (nother) (auxiliary) polymer, such as an elastomer and/or latex. It is also imaginable that rubber and/or elastomeric parts (particles) are dispersed within the composite to improve the flexibility and/or impact resistance at least to some extent. The core may (thus) be rigid, semi-flexible, or flexible, and so can be the floor covering element as such. The filler may be formed by fibres, such as glass fibers or synthetic or genuine leather fibers, and/or may be formed by dust-like particles. Here, the expression “dust” is understood as small dust-like particles (powder), like bamboo dust, wood dust, cork dust, or non-wood dust, like mineral dust, stone powder, in particular cement, and combinations thereof. The average particle size of the dust is preferably between 14 and 20 micron, more preferably between 16 and 18 micron. The primary role of this kind of filler is to provide the core, and the panel as such, sufficient hardness and/or to decrease the cost price of the core, and hence of the panel. Moreover, this kind of filler will typically also improve the impact strength of the core and of the panel as such. Preferably, the filler content in the composite material of the core is between 30 and 75% by weight of the composite material of the core, more preferably between 50 and 60% by weight of the composite material of the core. Preferably, the polymer content in the composite material of the core is between 25 and 70% by weight of the composite material of the core, more preferably between 40 and 50% by weight of the composite material of the core. The polymer can either be foamed or unfoamed. Preferably, the composite of the core comprises at least one filler selected from the group consisting of: a salt, a stearate salt, calcium stearate, and zinc stearate. Stearates have the function of a stabilizer, and lead to a more beneficial processing temperature, and counteract decomposition of components of the composite during processing and after processing, which therefore provide long-term stability. Instead of or in addition to a stearate, for example calcium zinc may also be used as stabilizer. The weight content of the stabilizer(s) in the composite will preferably be between 1 and 5%, and more preferably between 1.5 and 4%. The composite of the core preferably comprises at least one impact modifier comprising at least one alkyl methacrylate, wherein said alkyl methacrylate is preferably chosen from the group consisting of: methyl methacrylate, ethyl methacrylate, propyl methacrylate, isopropyl methacrylate, t-butyl methacrylate and isobutyl methacrylate. The impact modifier typically improves the product performance, in particular the impact resistance. Moreover, the impact modifier typically toughens the core layer and can therefore also be seen as toughening agent, which further reduces the risk of breakage. Often, the modifier also facilitates the production process, for example, as already addressed above, in order to control the formation of the foam with a relatively consistent (constant) foam structure. The weight content of the impact modifier in the composite will preferably be between 1 and 9%, and more preferably between 3 and 6%. At least one plastic material used in the core layer is preferably free of any (toxic) plasticizer in order to increase the desired rigidity of the core layer, which is, moreover, also favourable from an environmental point of view. The core and/or another layer of the panel may comprise wood-based material, for example, MDF, HDF, wood dust, bamboo, prefabricated wood, more particularly so-called engineered wood. This wood-based material may be part of a composite material of the core. Alternatively, the core is at least partially composed of another base material, such as a mineral material, like magnesium oxide, magnesium hydroxide, gypsum, (lightweight) concrete, and/or clay; and/or a wood or a wood-based material, such as HDF or MDF, or any other thermoplastic-free material, may be used as base material.

The density of the core typically varies from about 0.1 to 1.5 grams/cm³, preferably from about 0.2 to 1.4 grams/cm³, more preferably from about 0.3 to 1.3 grams/cm³, even more preferably from about 0.4 to 1.2 grams/cm³, even more preferably from about 0.5 to 1.2 grams/cm³, and most preferably from about 0.6 to 1.2 grams/cm³. It is imaginable that each panel comprises a plurality of core (sub) layers. Different core (sub) layers may have either identical compositions or different compositions, and/or different densities.

The floor covering element can be a sheet, which may be windable (flooring on a roll), or slab, or can e.g. be a panel or tile. The shape of the floor covering element is typically rectangular and may be square or oblong. Alternative shapes, like a triangular shape, a pentagonal shape, a hexagonal shape, or a parallelogrammatic shape, may also be applied as shape for the floor covering element according to the invention.

Preferably, the anti-slip texture of the floor covering element extends across the substantially entire upper surface of the floor covering element. This leads to an anti-slip of practically the whole upper surface of the floor covering element.

In a preferred embodiment, at least a fraction of the anti-slip substance is composed of a material chosen from the group consisting of: a mineral material, a glass material, a ceramic material, and a composite material. The anti-slip substance is typically a rigid material. The anti-slip substance should be wear-resisting to secure the anti-slip performance during the lifetime of the product. Preferably, at least a fraction of the anti-slip substance is composed of a material chosen from the group consisting of: carborundum, corundum, quartz, silica, glass particles, feldspar, clay, ceramic, carbon, textile, fused aluminium oxide, an auxiliary polymer deviating from the main polymer of the core, or combinations thereof. Examples of such an auxiliary polymer is polycarbonate, acetal, polyamide, and acrylic resins. Fused aluminium oxide offers more wear resistance than calcined aluminium oxide, and is therefore preferred over calcined aluminium oxide. In general, larger particle sizes typically increases the wear resistance.

The anti-slip substance may be formed by a layer embedded by the core, which may even be reinforcing the core, although the anti-slip substance may also be formed by anti-slip particles (particulate). In this latter case, the anti-slip particles are preferably uniformly dispersed in at least an upper zone of the core, and preferably throughout the core. In case the core is made by means of co-extrusion, wherein in separate core sublayers are initially produced by means of extrusion, after which the sublayer is laminated, typically by means of calendering, one could choose to only enrich a top sublayer of the core with anti-slip particles. Preferably, the anti-slip particles have an average particle size of between 0.015 mm to 1.0 mm. Also larger particles may be used, wherein the particles may e.g. be formed by chips. A predefined selection of particles with different particles sizes may be used, such as smaller and larger particles. Different particles may be composed of the same material, although it is also imaginable that at least two different materials are used for different particles. Preferably, at least a fraction of the particles used is larger than 0.2 mm, which facilitates to the realization of the anti-slip texture at the upper surface of the floor covering element. In fact, the decorative top structure is draped around the anti-slip substance, in particular anti-slip particles embedded in the core. It is conceivable that the—normally relatively thin decorative top structure—entirely covers the anti-slip substance, in particular the anti-slip particles. However, it can be preferred that the decorative top structure leaves at least a fraction of the anti-slip substance, in particular the anti-slip particles, uncovered by at least one layer of the decorative top structure, preferably each layer of the decorative top structure. For example, it is imaginable that at least one wear layer of the decorative top structure only covers the anti-slip particles partially, or not at all. This could enhance the anti-slip performance of the floor covering element. To this, it is preferred that at least a fraction of the anti-slip particles have (largest) diameter which exceeds the thickness of the decorative top structure.

Preferably, at least a fraction of the particles is coated with a pigmented coating, preferably a coloured coating and/or a glitter coating. Such a coating camouflages a typically dark (black or dark green) appearance of the anti-slip particles, such as silicon carbide (carborundum), which makes the appearance of the—typically visible—anti-slip particles more attractive. The coating may be a pigmented organic or inorganic coating. In case of an organic coating, epoxy, polyurethane, or acrylic resin could e.g. be used. An example of an inorganic coating is a ceramic glaze. Before coating the particle, a primer layer may be applied to the particles to improve the bonding of the coating to the particles. The coating of the anti-slip particles with a pigmented resin allows a range of colours (of choice) and reflectivities to be obtained whilst still maintaining the angular edges of the particles which provide the required slip resistance when used as anti-slip flooring. The pigment can be any colour and the colour can be solid or metallic.

The decorative top structure is preferably at least partially transparent or translucent, and wherein the anti-slip substance is at least partially visible through said decorative top structure.

Preferably, the anti-slip substance, in particular the anti-slip particles, are subjected to a surface modification treatment, which will improve the (chemical) bonding between the substance, in particular the particles, and the main polymer. This may lead to a seriously improved bonding strength which prevents particle-polymer interface separation due to temperature decrease. To this end, for example this surface treatment may be realized by a silane coupling agent, which can be expressed as Y—R—SiX3, and its greatest feature is that there are two groups with different functions and different properties contained in the same molecule, wherein:
X is a group, such as a siloxy group, an acetoxy group, or a halogen, which is capable of undergoing a hydrolysis reaction to form a silyl group (Si—OH), and X has the ability to bond with inorganic substances such as glass and silica;
Y is an organic group, such as a vinyl group, an amino group, an epoxy group, or etc., which is capable of reacting with a polymer to increase the reactivity and compatibility of the silane with the main polymer; and
R is a carbon chain having a saturated or unsaturated bond, through which Y and Si atoms are connected.

Since the silane coupling agent has two functional groups with organophilic capability and hydrophilic capability in the molecule of the silane coupling agent, it can be used as a “molecular bridge” for connecting inorganic materials and organic materials, and connecting two kinds of materials with different properties to form a coupling layer of inorganic phase-silane coupling agent-organic phase, thereby increasing the bonding strength between the main polymer and the anti-slip substance, in particular the anti-slip particles. Alternative coupling agents may also be used, such as a polymer comprising a polyamine amide, a polyamide, or an unsaturated polycarboxylic acid and more preferably is a high molecular weight version of one of these polymers. More preferably, the coupling agent is a polymer comprising a carboxylic acid salt of a polyamine amide, a phosphoric acid salt of a long chain carboxylic acid polyamine amide or a solution of a partial amide and alkylammonium salt of a higher molecular weight unsaturated polycarboxylic acid and polysiloxane copolymer. Any combinations or mixtures of various coupling agents can be used. The coupling agents, or traces thereof, are typically still present in the floor covering element as such.

The decorative top structure is preferably at least partially transparent or translucent. The decorative top structure may be composed of a single layer, such as a printed decorative layer or a wear layer, but is typically composed of a plurality of layers. Preferably, the decorative top structure preferably comprises at least one decorative layer and at least one transparent wear layer and/or transparent top coating covering said decorative layer. Said top coating is also referred to as lacquer layer. The wear layer is preferably made of polyvinyl chloride, polyurethane, and/or an acrylic resin. The decorative top structure may additionally comprise at least one back layer situated in between said decorative layer and the core, wherein said back layer is preferably made of a vinyl or polyurethane compound. A finishing layer may be applied in between the decorative layer and the wear layer. The decorative layer will be visible and will be used to provide the panel an attractive appearance. To this end, the decorative layer may have a design pattern, which can, for example be a wood grain design, a mineral grain design that resembles marble, granite or any other natural stone grain, or a colour pattern, colour blend or single colour to name just a few design possibilities. Customized appearances, often realized by digital printing during the panel production process, are also imaginable. The decorative top structure may also be formed by a single layer. In an alternative embodiment, the decorative top structure is omitted, thus not applied, in the panel according to the invention. In this latter embodiment, the upper side of the core constitutes the upper side of the panel.

The decorative layer may be formed at least partially by a (digitally) printed thermoplastic layer or a (digitally) printed film, in particular paper film or thermoplastic film. The thermoplastic material is used can be of various nature, but commonly PVC or TPU is preferred as material. The decorative layer may also be formed by an ink layer printed, preferably digitally printed, either directly or indirectly onto the core. Here, often a primer layer is applied onto the core, onto which primer layer the decorative print is digitally printed. The decorative top structure may at least partially made of at least one biobased material, such as a polymer, in particular TPU, based upon plant-based oils such as canola oil or castor oil. The decorative layer, in particular a wear layer thereof, may additionally comprise mineral components such as chalk, aluminium oxide, graphene, and combinations thereof. This combines sustainability with extremely high levels of resilience for an improved panel performance in terms of acoustic properties, indentation resistance, etcetera.

Preferably, at least one wear layer and/or the top coating may be enriched with further wear-resisting anti-slip particles at least partially embedded in said wear layer, wherein said further wear-resisting anti-slip particles partially define the textured upper surface of the decorative floor covering element. This could further enhance the anti-slip effect of the floor covering element according to the invention.

It is imaginable that core comprises at least two polymer layers, preferably composed of the same main polymer, laminated together, wherein at least one anti-slip substance is embedded as anti-slip layer and/or anti-slip grit in between said polymer layers. An upper layer of said polymer layer should be sufficiently thin to allow the upper surface of the floor covering element to become textured by said anti-slip layer.

Preferably, the upper side of the core has a nominal base level, wherein the anti-slip substance embedded by the core protrudes at least 0.1 mm, preferably at least 0.2 mm, more preferably at least 0.3 mm, with respect to said base level. This typically leads to sufficient protrusion to provide the upper surface of the floor covering element with sufficient texture to realize a desired anti-slip performance. Similarly, the upper side of the decorative top structure preferably has a nominal base level, wherein the anti-slip substance embedded by the core causes portions of the decorative top structure to protrude at least 0.1 mm, preferably at least 0.2 mm, more preferably at least 0.3 mm, with respect to said base level. This degree of protrusion typically secures a sufficient anti-slip effect.

Floor covering element according to one of the foregoing claims, wherein the anti-slip substance, in particular anti-slip particles, embedded in the core have a minimum Moh's hardness of 6, preferably more than 8, more preferably more than 9. The particles may have an irregular or a regular shape.

Preferably, the floor covering element is a floor panel with a first panel edge comprising a first coupling profile, and a second panel edge comprising a complementary second coupling profile being designed to, either directly or indirectly, interlock adjacent panels. In case of direct interlocking, a coupling profile of a panel will directly co-act with a complementary coupling profile of an adjacent panel. In case of indirect interlocking, typically a separate coupling structure (connecting element) is used to mutually couple of plurality of panels, wherein a coupling profile of each of said panel is coupled to the coupling structure. In coupled condition, the floor panels may abut each other, or, alternatively, may be positioned at a distance from each other.

The floor panel may further comprise a third panel edge comprising a third coupling profile, and a fourth panel edge comprising a complementary fourth coupling profile being designed to, either directly or indirectly, interlock adjacent panels.

In a preferred embodiment, the first coupling profile and/or the third coupling profile comprises: an upward tongue, at least one upward flank lying at a distance from the upward tongue, an upward groove formed in between the upward tongue and the upward flank wherein the upward groove is adapted to receive at least a part of a downward tongue of a second coupling profile of an adjacent panel, and at least one first locking element, preferably provided at a distant side of the upward tongue facing away from the upward flank, and wherein the second coupling profile and/or the fourth coupling profile comprises: a first downward tongue, at least one first downward flank lying at a distance from the downward tongue, a first downward groove formed in between the downward tongue and the downward flank, wherein the downward groove is adapted to receive at least a part of an upward tongue of a first coupling profile of an adjacent panel, and at least one second locking element adapted for co-action with a first locking element of an adjacent panel, said second locking element preferably being provided at the downward flank.

Preferably, the first locking element comprises a bulge and/or a recess, and wherein the second locking element comprises a bulge and/or a recess. The bulge is commonly adapted to be at least partially received in the recess of an adjacent coupled panel for the purpose of realizing a locked coupling, preferably a vertically locked coupling. It is also conceivable that the first locking element and the second locking are not formed by a bulge-recess combination, but by another combination of co-acting profiled surfaces and/or high-friction contact surfaces. In this latter embodiment, the at least one locking element of the first locking element and second locking element may be formed by a (flat of otherwise shaped) contact surface composed of a, optionally separate, plastic material configured to generate friction with the other locking element of another panel in engaged (coupled) condition. Examples of plastics suitable to generate friction include:
Acetal (POM), being rigid and strong with good creep resistance. It has a low coefficient of friction, remains stable at high temperatures, and offers good resistance to hot water;
Nylon (PA), which absorbs more moisture than most polymers, wherein the impact strength and general energy absorbing qualities actually improve as it absorbs moisture. Nylons also have a low coefficient of friction, good electrical properties, and good chemical resistance;
Polyphthalamide (PPA). This high performance nylon has through improved temperature resistance and lower moisture absorption. It also has good chemical resistance;
Polyetheretherketone (PEEK), being a high temperature thermoplastic with good chemical and flame resistance combined with high strength. PEEK is a favourite in the aerospace industry;
Polyphenylene sulphide (PPS), offering a balance of properties including chemical and high-temperature resistance, flame retardance, flowability, dimensional stability, and good electrical properties;
Polybutylene terephthalate (PBT), which is dimensionally stable and has high heat and chemical resistance with good electrical properties;
Thermoplastic polyimide (TPI) being inherently flame retardant with good physical, chemical, and wear-resistance properties.
Polycarbonate (PC), having good impact strength, high heat resistance, and good dimensional stability. PC also has good electrical properties and is stable in water and mineral or organic acids; and
Polyetherimide (PEI), maintaining strength and rigidity at elevated temperatures. It also has good long-term heat resistance, dimensional stability, inherent flame retardance, and resistance to hydrocarbons, alcohols, and halogenated solvents.

In the abovementioned embodiment, it is imaginable that the first coupling profile (and/or third coupling profile) and the second coupling profile (and/or fourth coupling profile) are configured such that in coupled condition a pretension is existing, which forces coupled panels at the respective edges towards each other, wherein this preferably is performed by applying overlapping contours of the first coupling profile (and/or third coupling profile) and the second coupling profile (and/or fourth coupling profile), in particular overlapping contours of downward tongue and the upward groove and/or overlapping contours of the upward tongue and the downward groove, and wherein the first coupling profile (and/or third coupling profile) and the second coupling profile (and/or fourth coupling profile) are configured such that the two of such panels can be coupled to each other by means of a fold-down movement and/or a vertical movement, such that, in coupled condition, wherein, in coupled condition, at least a part of the downward tongue of the second coupling profile (and/or fourth coupling profile) is inserted in the upward groove of the first coupling profile (and/or third coupling profile), such that the downward tongue is clamped by the first coupling profile (and/or third coupling profile) and/or the upward tongue is clamped by the second coupling profile (and/or fourth coupling profile).

It is imaginable that the first coupling profile is configured to co-act with the second coupling profile as well as with the fourth coupling profile, and that the third coupling profile is also configured to co-act with the second coupling profile as well as with the fourth coupling profile.

In an embodiment of the panel according to the invention, the first coupling profile and/or the third coupling profile comprises: a sideward tongue extending in a direction substantially parallel to the upper side of the core, at least one second downward flank lying at a distance from the sideward tongue, and a second downward groove formed between the sideward tongue and the second downward flank, and wherein the second coupling profile and/or the fourth coupling profile comprises: a third groove configured for accommodating at least a part of the sideward tongue of the third coupling profile of an adjacent panel, said third groove being defined by an upper lip and a lower lip, wherein said lower lip is provided with an upward locking element, wherein the third coupling profile and the fourth coupling profile are configured such that two of such panels can be coupled to each other by means of a turning movement, wherein, in coupled condition: at least a part of the sideward tongue of a first panel is inserted into the third groove of an adjacent, second panel, and wherein at least a part of the upward locking element of said second panel is inserted into the second downward groove of said first panel.

It is conceivable that each first coupling profile and each third coupling profile is compatible—hence may co-act and interlock—with each second coupling profile and each fourth coupling profile. This may also apply in case interlocking coupling profiles do not have a completely complementary shape.

Preferably, the coupling profiles make integral part of the core, wherein the anti-slip substance, in particular the anti-slip particles, embedded by the core textures at least a part of the surface of at least one coupling profile.

It is imaginable that the anti-slip performance of the floor covering element according to the invention could further be improved in case the upper side of the core and/or the upper side of the decorative top structure is mechanically roughened and/or (otherwise) actively roughened. This mechanical roughening may, for example, be realised by abrasion, sandblasting, hammering, brushing, washing, etcetera. The texture of the floor covering element could become more pronounced by this roughening step, which could be in favour of the anti-slip properties. The added texture by roughening could be according to a predefined pattern, or alternatively, could lead to a more random roughening (texturing) of the upper surface of the floor covering element.

Preferably, the thickness of the core is situated between 3 and 30 mm, more preferably between 3 and 15 mm, most preferably between 3 and 12 mm. The thickness of the decorative top structure is typically less than 1.5 mm, preferably less than or equal to 1.2 mm, and more preferably less than 0.5 mm, in particular less than 0.4 mm, such as 0.3 mm.

Preferably, between 1.5 and 60 g/m², more preferably between 3 and 25 g/m², of anti-slip particles are present in the core. Alternatively or additionally, the quantity of anti-slip substance, in particular the quantity of anti-slip particles, in the core is preferably situated between 1% and 75% by weight of the core, more preferably between 5 and 50% by weight of core.

The invention also relates to an anti-slip floor covering comprising a plurality of, preferably interconnected, floor covering elements, in particular floor panels, according to the invention. In case of interconnected floor covering elements, the floor covering elements could be connected directly or indirectly to each other. As mentioned above, the floor covering elements, in particular floor panels, could be directly connected to each other. To this end, floor panels are preferably provided with coupling profiles, wherein coupling profiles of adjacent floor panels are configured to (directly) co-act with each other, to secure the floor panels, preferably both in horizontal and vertical direction. It is also imaginable that the floor covering comprises intermediate coupling structures, such as clamps, wherein adjacent floor panels are mutually coupled by means of at least one such a coupling structure. To this latter end, the floor panels may or may not be provided with coupling profiles.

### BRIEF DESCRIPTION OF THE DRAWINGS

The terms FIG., FIGS., Figure, and Figures are used interchangeably to refer to the corresponding figures in the drawings.

The invention will be further elucidated according to the following non-limitative figures:

FIG. 1 shows a perspective view of an embodiment of a decorative panel according to the invention; and

FIG. 2 shows a schematic transversal cross-section along line B-B of an embodiment of a decorative panel according to the invention; and

FIG. 3 shows a schematic transversal cross-section along line A-A of an embodiment of a decorative panel according to the invention; and

FIG. 4 shows a transversal cross-section of an embodiment of a decorative panel covering according to the invention; and

FIG. 5 shows a detailed view of a partial cross-section of an embodiment of a decorative covering according to the invention.

### DESCRIPTION OF THE INVENTION

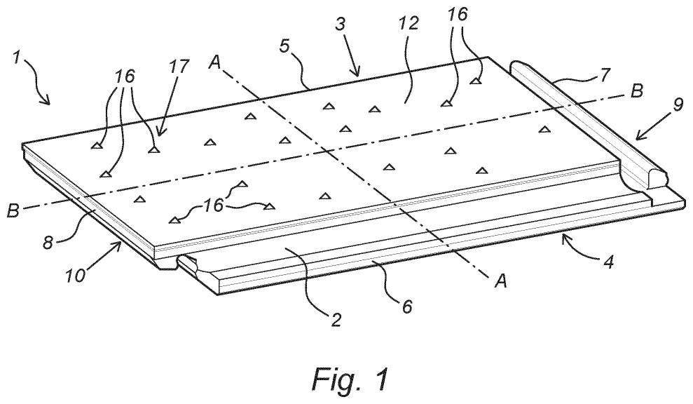

FIG. 1 shows a perspective view of an embodiment of a decorative panel 1 according to the present invention. The panel is of a rectangular shape having a length extending longitudinally along line B-B, and a width extending transversally along line A-A. The panel 1 is provided with a core 2 provided with an upper side and a lower side. The panel is provided with a decorative top structure 12 affixed, either directly or indirectly, on said upper side of the core 2. The sides of the decorative panel 1 are provided with coupling profiles 5, 6, 7, 8. At opposite edges 9, 10 a first panel edge 3 comprising a first coupling profile 5, and a second panel edge 4 comprising a second coupling profile 6. The coupling profiles are designed such that the second coupling profile 6 engage interlockingly with said first coupling profile 5 of an adjacent panel, both in horizontal and in vertical direction. The panel 1 is further provided with a third coupling profile 7 and fourth coupling profile 8 at opposite edges 9 and 10 respectively, which also interlockingly engage. The core 2 of the panel 1 comprises at least one main polymer and a wear-resisting anti-slip substance which is at least partially embedded in said main polymer. The wear-resisting anti-slip substance textures an upper side of the core 2, and at least partially defines a textured upper surface 17 of the decorative floor covering element 1. Hence, the wear-resisting anti-slip substance at least partially extends beyond an upper side of the core 2. The portion extending beyond the core 2 may as such form the textured upper surface 17 of the floor covering element 1. The textured upper surface 17 may increase the grip of said textured upper surface 17. Preferably, said anti-slip substance is at least partially composed of anti-slip particles 16, wherein said particles protrude beyond an upper side of the core 2A, such as to form at least a part of the textured upper surface 17. Preferably, said anti-slip particles 16 are at least partially embedded in the core 2 of the decorative floor covering 1. An additional benefit of the anti-slip particles 16 is that the sound dampening property of the decorative floor covering 1 may be improved. The sound waves travelling through the panel 1 are disturbed by the anti-slip particles 16 and hence damped. Said anti-slip particles 16 may for example be composed out of a material chosen from the group consisting of carborundum, quartz, silica, glass particles, feldspar, clay, ceramic, carbon, textile, fused aluminium oxide, an auxiliary polymer deviating from the main polymer of the core, or combinations thereof. Preferably having an average particle size between 0.015 mm to 1.0 mm. The particles 16 may be coated with a pigmented coating, preferably a coloured coating and/or a glitter coating may be used to this end.

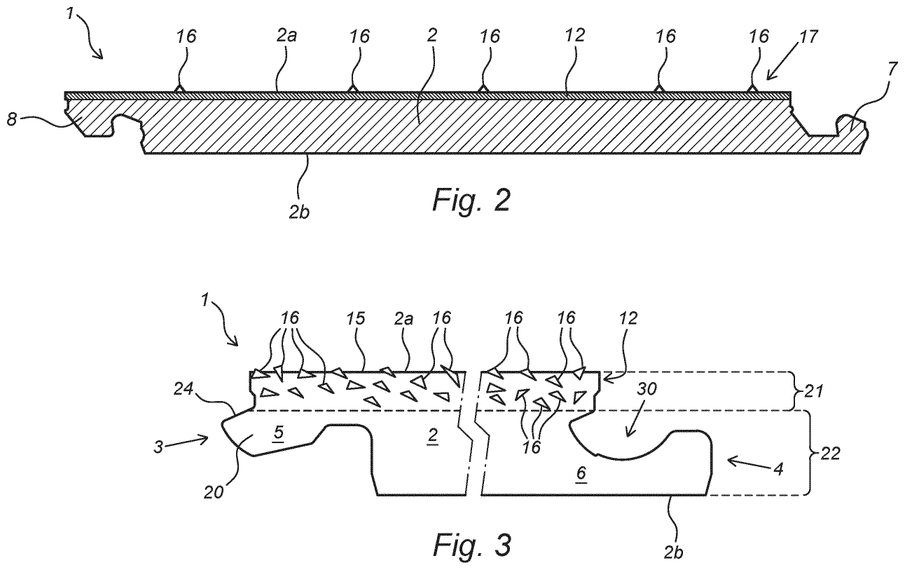

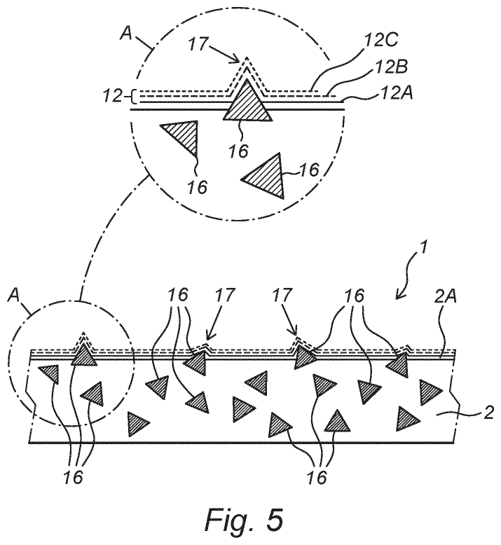

FIG. 2 shows a transversal cross-section of an embodiment of a decorative panel 1 according to the present invention, provided with a core 2, a decorative top structure 12 and coupling profiles 7,8. The decorative top structure 12 is directly or indirectly affixed to the upper side 2a of the core 2. For example, the top structure 12 may be glued, by means of an adhesive, and/or fused onto the core 2. The decorative top structure 12 may comprise at least one wear layer and a decorative layer (FIG. 5). The upper side 2a of the core 2 may be a textured side in particular when the core comprises a wear-resisting anti-slip substance 16. In this embodiment the anti-slip substance 16 is at least partially formed by anti-slip particles 16 which are embedded in the core 2. Said anti-slip particles 16 at least partially protrude with respect to a nominal base level of the core 2. As such, the anti-slip particles 16 define, at least partially, a textured upper side 2A of the core 2 and an upper surface 17 of the panel 1 as such. The anti-slip particles 16 may protrude at least 0.2 mm with respect to the nominal base level of the core 2, preferably at least 0.3 mm. The lower side of the core 2b may be the lower side of the panel 1 or may be affixed to a (not shown) base layer. The panel 1 may as such be co-extruded, as shown in FIG. 3.

FIG. 3 shows in transversal cross-section the first coupling part 5 at side edge 3 and the second coupling part 6 at opposing side edge 4. The first coupling part 5 comprises a sideward tongue 20 and the second coupling part 6 comprises a recess 30 for accommodating at least a part of the sideward tongue 20 of a further panel. The recess 30 is configured to actively co-act with a sideward tongue 20 of another panel 1, in a coupled condition of such panels 1. Although these specific coupling parts 5, 6, are shown the present invention is not limited thereto. It is conceivable that a different type of coupling part 5, 6 may be applied. The figure depicts in particular a co-extruded panel 1 wherein the core 2 comprises an upper core portion 21 and a lower core portion 22. Said upper and lower core portion 21, 22 may be affixed by means of the co-extrusion process. The upper core portion 21 comprises the wear-resisting anti-slip substance 16. The wear-resisting anti-slip substance 16 is in this non-limitative embodiment partially composed out of anti-slip particles 16. At least some of the anti-slip particles 16 protrude through the upper side 2a of the core 2. The particles 16 at least partially define a textured upper surface 17 of the decorative floor covering 1. By applying the wear-resisting anti-slip particles 16 only in the upper core portion 21, material and hence cost may be saved. It is also conceivable that both the upper and the lower core portion 21, 22 are provided with anti-slip particles 16.

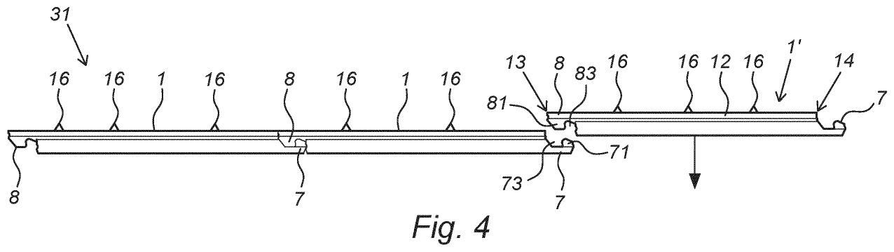

FIG. 4 shows a decorative covering 31 consisting of a plurality of interlocked panels 1, 1′ according to the invention. The figure shows how the coupling profiles 7 and 8 can be coupled to each other when connecting a panel 1 and a panel 1′ to each other. The panel 1′ is hereby moved vertically downwards along the arrow, wherein the profiles 7 and 8 engage with each other by receiving upward tongue 71 in downward groove 83 and receiving downward tongue 81 in upward groove 73. A decorative top structure 12 is directly or indirectly affixed to the upper side 2a of the core 2. For example, the top structure 12 may be glued, by means of an adhesive, and/or fused onto the core 2. The decorative top structure 12 may comprise at least one polymeric wear layer and a decorative layer (FIG. 5). The upper side 2a of the core 2 may have a textured side, for example when the core comprises a wear-resisting anti-slip substance. In this embodiment the anti-slip substance 16 is at least partially formed by anti-slip particles 16 which are embedded in the core 2. Said anti-slip particles 16 at least partially protrude with respect to a nominal base level of the core 2. As such, the anti-slip particles 16 define, at least partially, a textured upper surface 17 of the panel 1 as such.

FIG. 5 shows yet another embodiment of the decorative panel 1 according to the invention. This figure shows the core 2 of the panel 1, wherein anti-slip particles 16 are embedded within said core 2. At least some of the particles 16 protrude through the upper side 2A of the core 2. The decorative top structure 12 is affixed directly or indirectly on the upper side 2A of the core 2. The circle A is enlarged and shows a more detailed view of the different layers 12A, 12B, 12C of the decorative top structure 12. The decorative top structure comprises a decorative layer 12A, a wear layer 12B, and a top coating 12C. It is conceivable that the particles 16 protrude through the decorative layer 12A, which may be a décor image, or the decorative layer may follow the contours over said particles 16. The wear layer 12B and the top coating 12C may be provided on top of the decorative layer 12A. The figure clearly shows the textured upper surface 17 of the panel 1. Although not shown in this embodiment, it is conceivable that the particles 16 protrude through the wear layer 12B of the decorative top structure 12 and/or through the top coating 12C. Hence, the particles 16 may be directly exposed. Different combinations thereof are also conceivable, and may benefit to the looks and feels of the panel 1 as such.

The above-described inventive concepts are illustrated by several illustrative embodiments. It is conceivable that individual inventive concepts may be applied without, in so doing, also applying other details of the described example. It is not necessary to elaborate on examples of all conceivable combinations of the above-described inventive concepts, as a person skilled in the art will understand numerous inventive concepts can be (re) combined in order to arrive at a specific application. Various embodiments of the panel as described above and in the appended claims may be combined with this alternative panel configuration.

By “horizontal” is meant a direction which extends parallel to a plane defined by the floor covering element, and which may intersect the core. By “vertical” is meant a direction which is perpendicular to said plane defined by the floor covering element.

The ordinal numbers used in this document, like “first”, “second”, and “third” are used only for identification purposes. Hence, the use of the expressions “third locking element” and “second locking element” does therefore not necessarily require the co-presence of a “first locking element”.

By “complementary” coupling profiles is meant that these coupling profiles can cooperate with each other. However, to this end, the complementary coupling profiles do not necessarily have to have complementary forms. The “floor covering element” according to the invention may also applied as wall covering element, ceiling covering element, or alternative covering element. In case in this document reference is made to a “floor tile” or “floor panel”, these expressions may be replaced by expressions like “tile”, “wall tile”, “ceiling tile”, “covering tile”.

It will be apparent that the invention is not limited to the working examples shown and described herein, but that numerous variants are possible within the scope of the attached claims that will be obvious to a person skilled in the art.

The verb “comprise” and conjugations thereof used in this patent publication are understood to mean not only “comprise”, but are also understood to mean the phrases “contain”, “substantially consist of”, “formed by” and conjugations thereof.

1-26. (canceled)

27. A decorative anti-slip floor covering element, in particular a floor panel, comprising:
a core provided with an upper side and a lower side,
a decorative top structure affixed, either directly or indirectly, on said upper side of the core,
wherein the core comprises at least one main polymer and a wear-resisting anti-slip substance at least partially embedded in said main polymer, wherein said anti-slip substance textures the upper side of the core, wherein the textured upper side of the core at least partially defines a textured upper surface of the decorative floor covering element.

28. The floor covering element according to claim 27, wherein at least a fraction of the anti-slip substance is composed of a material chosen from the group consisting of: a mineral material, a glass material, a ceramic material, and a composite material.

29. The floor covering element according to claim 27, wherein at least a fraction of the anti-slip substance is composed of a material chosen from the group consisting of: carborundum, quartz, silica, glass particles, feldspar, clay, ceramic, carbon, textile, fused aluminium oxide, an auxiliary polymer deviating from the main polymer of the core, or combinations thereof.

30. The floor covering element according to claim 27, wherein the decorative top structure is at least partially transparent or translucent.

31. The floor covering element according to claim 27, wherein the anti-slip substance is at least partially composed of anti-slip particles.

32. The floor covering element according to claim 27, wherein the anti-slip particles have an average particle size of between 0.015 mm to 1.0 mm.

33. The floor covering element according to claim 31, wherein at least a fraction of the particles is coated with a pigmented coating, preferably a coloured coating and/or a glitter coating.

34. The floor covering element according to claim 31, wherein at least a fraction of the anti-slip particles is loosely dispersed throughout at least one zone of the core, preferably throughout the entire core.

35. The floor covering element according to claim 27, wherein at least a part of the anti-slip substance embedded in the core is left uncovered by the decorative top structure.

36. The floor covering element according to claim 27, wherein the core comprises at least two polymer layers, preferably composed of the same main polymer, laminated together, wherein at least one anti-slip substance is embedded as anti-slip layer in between said polymer layers.

37. The floor covering element according to claim 27, wherein the upper side of the core has a nominal base level, wherein the anti-slip substance embedded by the core protrudes at least 0.1 mm, preferably at least 0.2 mm, more preferably at least 0.3 mm, with respect to said base level.

38. The floor covering element according to claim 27, wherein the upper side of the decorative top structure has a nominal base level, wherein the anti-slip substance embedded by the core causes portions of the decorative top structure to protrude at least 0.1 mm, preferably at least 0.2 mm, more preferably at least 0.3 mm, with respect to said base level.

39. The floor covering element according to claim 27, wherein the anti-slip substance, in particular anti-slip particles, embedded in the core have a minimum Moh's hardness of 6.

40. The floor covering element according to claim 27, wherein the main polymer of the core is formed by a thermoplastic material chosen from the group consisting of: PVC, PET, PP, PS and thermoplastic polyurethane (TPU).

41. A decorative anti-slip floor covering, comprising a plurality of, preferably interconnected, floor covering elements according to claim 27.
